(19) United States
(12) Patent Application Publication
(10) Pub. No.: US 2007/0053256 A1
(43) Pub. Date: Mar. 8, 2007

(54) Method and device for adjusting an amplification for producing a focus error signal

(76) Inventors: Christian Büchler, VILLINGEN-SCHWENNINGEN (DE); Holger Hofmann, Thousand Oaks, CA (US)

Correspondence Address: Joseph S Tripoli;Patent Operations, Thomson Licensing Inc, PO Box 5312, Princeton, NJ, 08543-5312, US

(21) Appl. No.: 10/556,618

(22) PCT Filed: May 14, 2004
(86) PCT No.: PCT/EP04/05197

§ 371 Date: Nov. 15, 2005

(30) Foreign Application Priority Data
May 16, 2003 (DE) 10322426.2

(51) Int. Cl. G11B 7/00

(52) U.S. Cl. 369/44.29

(57) ABSTRACT

In drives for optical storage media, a focus error signal generated by means of weighted addition from main beam and secondary beam focus error signals always contains an undesired component of the track error signal whenever the weighting factors are not exactly tuned to the optical and mechanical properties of the drive actually present and of the storage medium. The invention describes methods for tuning the weighting factors automatically to these properties. The methods are suitable for use directly after the insertion of the storage medium, while some can also be applied without interruption during the writing or reading operation.

The invention relates to control methods and apparatuses for generating a focus error signal in devices for reading from and writing to optical storage media, in particular for setting gain or weighting factors in the course of control.

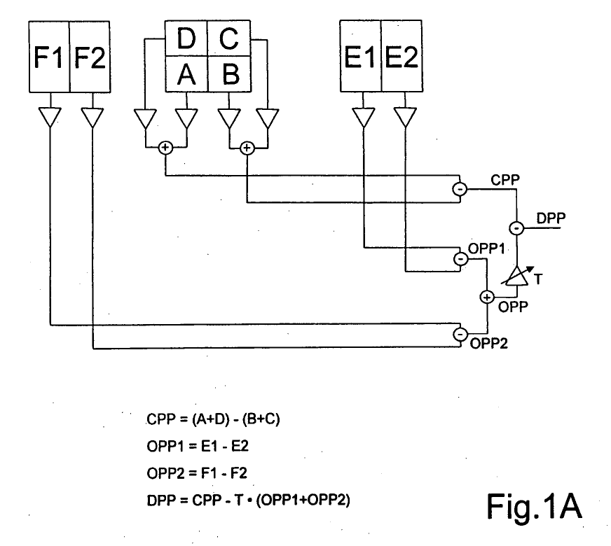

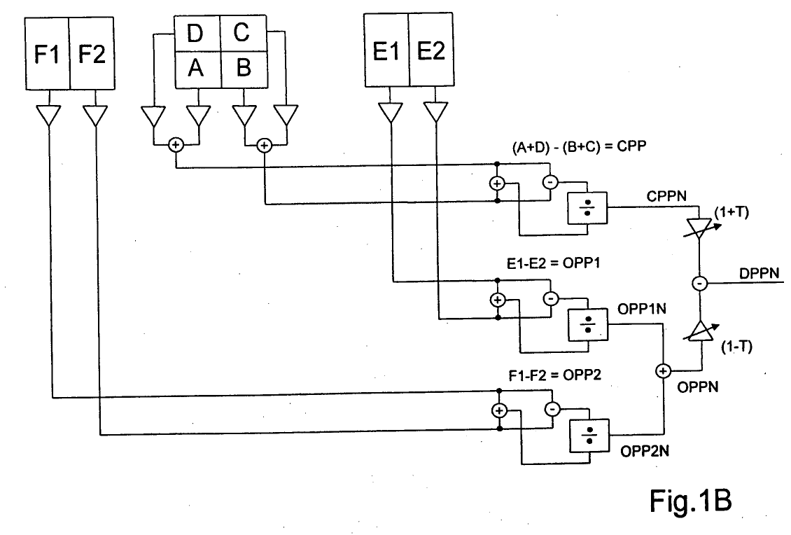

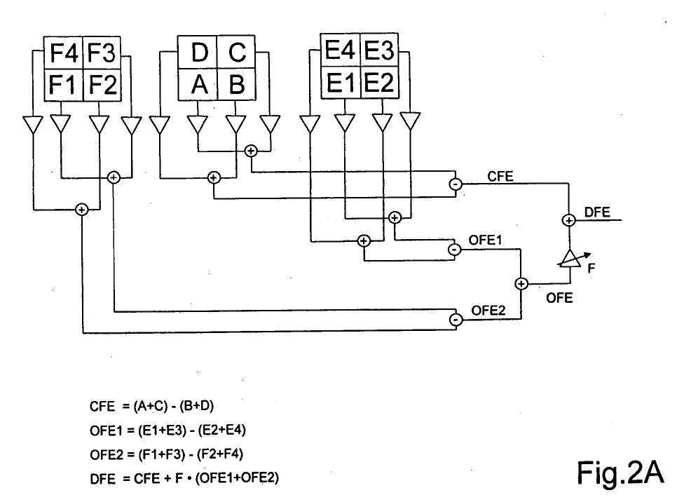

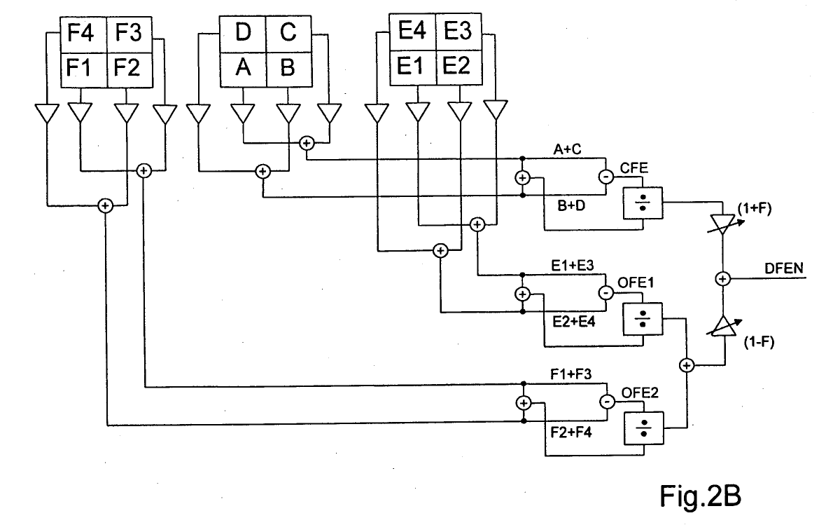

One of the widespread methods for forming a track error signal is the differential push-pull method DPP. The DPP method is a method that scans the optical storage medium with the aid of three beams. The aim of the DPP method is to form, with the aid of the means shown by way of example in FIG. 1A, a track error signal DPP which has no offset dependence on the position of the objective lens relative to the optical axis of the scanner. If the photodetector used is additionally designed in each case as a four-quadrant detector both for the main beam and for the secondary beams, a focus error signal can be formed both for the secondary beams and for the main beam. A previously known method for forming an improved focus error signal adds the focus error signal components of the main beam and of the secondary beams, the components of the secondary beams being weighted relative to the main beam in accordance with their intensity. This method is frequently termed differential focus method or differential astigmatism method. FIG. 2A shows the block diagram of an arrangement for determining a differential focus error signal DFE using the differential focus method.

It is advantageous both for the track error components and for the focus error components of the main beam and/or of the secondary beams to be respectively normalized relative to their sum. This is shown in FIG. 1B for a normalized differential push-pull signal DPPN and in FIG. 2B for a normalized differential focus error signal DFEN.

Irrespective of the normalization, the weighting between main beam and secondary beam error signals can be performed in this case in only one signal branch, as shown in FIGS. 1A and 2A with the weighting factors T or F, respectively; or be performed in both signal branches as shown in FIGS. 1B and 2B, respectively, with the aid of the weighting factors 1+T, 1−T and 1+F, 1−F.

Only the DFE method is to be considered below:

The scanning beam of an optical scanner, see FIG. 3, consists of three beams in the case of application of the differential focus method. In order to achieve this split into three beams, an optical grating 3 is inserted into the beam path of the light source 1. The main beam or so-called zeroth order beam, which reads the information, which is to be scanned, of a track of an optical storage medium, usually contains the largest part, for example 80-90%, of the optical information. The two secondary beams or ±1st order beams respectively contain the remainder, approximately 5-10%, of the total light intensity. In this case, it is assumed by way of simplification that the light energy of the higher diffraction orders of the grating are zero.

The optical grating is installed such that in the case of media where writing is onto groove and land the imaging of the two secondary beams strikes precisely the middle of the secondary tracks of type L, or, in the case of media where writing is only onto the groove G, strikes precisely the region between two tracks next to the track of type G read by the main beam. Since it is to be possible for the secondary beams and the main beam to be separated optically from one another, the positions of their images on the storage medium and on the detector are separated from one another. If the medium is rotating, one of the secondary beams is located in front of the main scanning beam in the reading direction, and the other secondary beam is located behind the main scanning beam.

On the return path to the photodetector, the reflected beams traverse an astigmatically acting optical component, for example a cylindrical lens. Two focal points differing from one another when seen in the x- and y-directions arise downstream of the cylindrical lens. A focus error signal can be generated from each of the scanning beams and is dependant on the position of the beam relative to the track scanned by it. The focus error signal of each scanning beam chiefly contains in this case a component that returns information relating to the vertical distance of the objective lens from the information layer of the optical storage medium. Contained in addition is a focus offset component that is independent of the vertical distance but is a function of the type of track respectively scanned and of the horizontal position of the scanning beams from the tracks. The amplitude of this offset component is a function of the geometry of the tracks, described, for example, by track width, track spacing or the track depth of G and L, and thus permits a statement to be made in relation to these variables.

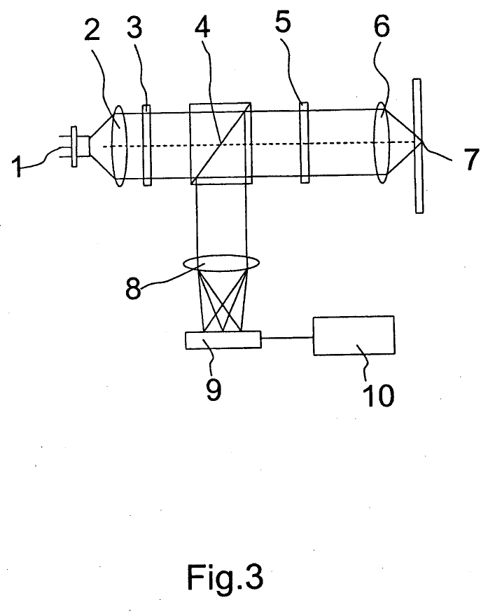

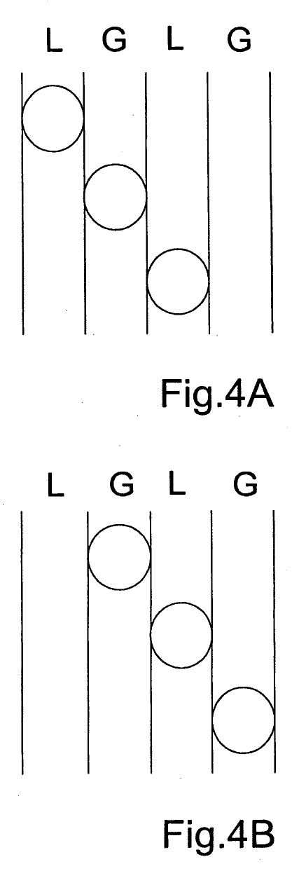

As already said above and shown in FIG. 4A, the optical grating is typically adjusted such that the secondary scanning beams scan precisely the middle of a secondary track L, when the main scanning beam detects the middle of a track G. If the objective lens is displaced relative to the tracks of the optical storage medium, the main scanning beam is displaced, for example, such that it scans precisely the middle of a secondary track L. In this case, the secondary scanning beams respectively lie precisely on the middle of a track G, as shown in FIG. 4B.

The secondary scanning beams therefore always have the track position complementary to the track position of the main scanning beam. Since the abovementioned focus offset components of the main scanning beam and the secondary scanning beams have mutually different signs depending on track type, given a correct weighting of secondary beam error signals relative to main beam error signals these focus offset components precisely cancel one another out when added, while the focus error components are added to one another.

This has the advantage that, for example, when scanning a medium pre-recorded both on G and L, there is no need to set any focus offset values differing from one another in order to read from or write to the respective track type. A further advantage resides in that in the event of a track jump the focus offset of the crossed tracks does not differ, and therefore there is no need when crossing tracks for the focus controller to adjust the focus offset that varies with the track crossing frequency. This results in a higher level of stability of the focus control during the track jump.

A precondition for the focus offset components to cancel one another out precisely is that gain adjustment, which determines the weight of the main beam signals relative to the weight of the secondary beam signals, is adjusted to a correct value.

An object of the invention is to describe methods and apparatuses that adjust the weights such that during the weighted addition of the main beam signal and the secondary beam signal the focus offset components contained in these and dependent on the horizontal position relative to the track cancel one another out. According to the invention, use is made of the fact that in the event of overweighting or underweighting of the main beam component relative to the secondary beam components the resulting differential focus error signal DFE contains a component that is a function of a focus offset and is in phase or in antiphase with a differential focus offset signal DFO. In other words: given the presence of a track crossing operation it is possible to detect whether the weighting is too large or too small from the phase angle of a component, occurring as a function of the focus offset, in the DFE signal, relative to the DFO signal.

It is therefore proposed according to the invention for adjusting a weighting factor in a device for reading from and/or writing to optical recording media which generates a focus error signal DFE in accordance with the differential focus error method, to switch on the focus control loop, to generate the differential focus error signal, to initiate a track crossing operation, to set the differential focus error signal and a measurement signal into relation with one another, and to change the weighting factor as a function of the differential focus error signal set into relation. This can be implemented advantageously by means of digital signal processing or by means of a digital signal processor. Advantages reside in the simple implementation and compensation of any possible changes in the properties of a device according to the invention, in particular of the optical scanner and of the focus control loop as a consequence of heating or of other influences, even during operation. Use is to be made here as measurement signal of a signal that does not contain a component of the differential focus error signal DFE, and that is not correlated with the latter in the ideal case of a correctly set weighting factor. The measurement signal is also denoted as zero signal on the basis of these properties. If a correlation is present, this is an indication of an undesired signal component, that is to say of maladjustment of the weighting; which is established by setting the differential error signal into relation with the zero signal.

An adjustment method according to the invention also consists in initiating a track crossing operation and jointly evaluating by multiplication the signal DFE, as a first measurement signal, and a second, differently formed measurement signal, the second measurement signal being constituted here such that it has its extreme values at the middles of groove G and land L. Information relating to the distance of the objective lens from the recording medium, and relating to the radial position of the beams relative to the tracks, is contained in the two measurement signals—in different components. Produced at the output of the multiplier as a result of the evaluation is an oscillating DC voltage whose signage represents the phase and whose magnitude represents the absolute value of the component of the DFE signal which is a function of focus offset. The weights are adjusted according to the invention under the control of this result; this is performed in a stepwise, iterative approximation to the correct value of the weighting, or alternatively the next weighting adjustment is carried out on the basis of a gradient calculation.

The track crossing operation required in accordance with the invention is carried out by initiating a track jump by means of a control pulse with the tracking control loop switched on. Alternatively, track crossing operations also take place with the tracking control loop switched off because of the eccentricity of the optical storage medium.

In one embodiment of the invention, the second measurement signal is formed from the control pulse ATON, GATE initiating the track crossing operation, or from a differential focus offset signal DFO. The joint evaluation of the measurement signals comprises an integration of the product of the two measurement signals to form an evaluation signal and, thereafter, comparison of the latter with a comparison interval. When the evaluation signal does not lie in the comparison interval, the branch weights T, F are varied in at least one adjustment step such that the evaluation signal changes toward the comparison interval.

In other words: in drives for optical storage media a focus error signal generated by means of weighted addition from main beam and secondary beam focus error signals always contains an undesired component of the track error signal whenever the weighting factors are not exactly tuned to the optical and mechanical properties of the drive actually present and of the storage medium. The invention describes methods for tuning the weighting factors automatically to these properties. The methods are suitable for use directly after the insertion of the storage medium, while some can also be applied without interruption during the writing or reading operation.

The present invention is explained in more detail below with the aid of preferred exemplary embodiments and with reference to the attached drawings, in which:

FIG. 1A shows an arrangement of the prior art for obtaining a track error signal DPP using the differential push-pull method,

FIG. 1B shows an arrangement for obtaining a normalized track error signal DPPN with the aid of normalizing and weighting the two part signals CPPN, OPPN,

FIG. 2A shows an arrangement of the prior art for obtaining a differential focus error signal DFE,

FIG. 2B shows an arrangement for obtaining a normalized differential focus error signal DFEN with the aid of normalizing and weighting the two part signals CFEN, OFEN,

FIG. 3 shows the design of an optical scanner,

FIG. 4A shows a schematic arrangement of tracks and scanning beams in the case of which the main scanning beam falls onto the middle of a track G,

FIG. 4B shows a schematic arrangement of tracks and scanning beams in the case of which the main scanning beam falls onto the middle of a secondary track L,

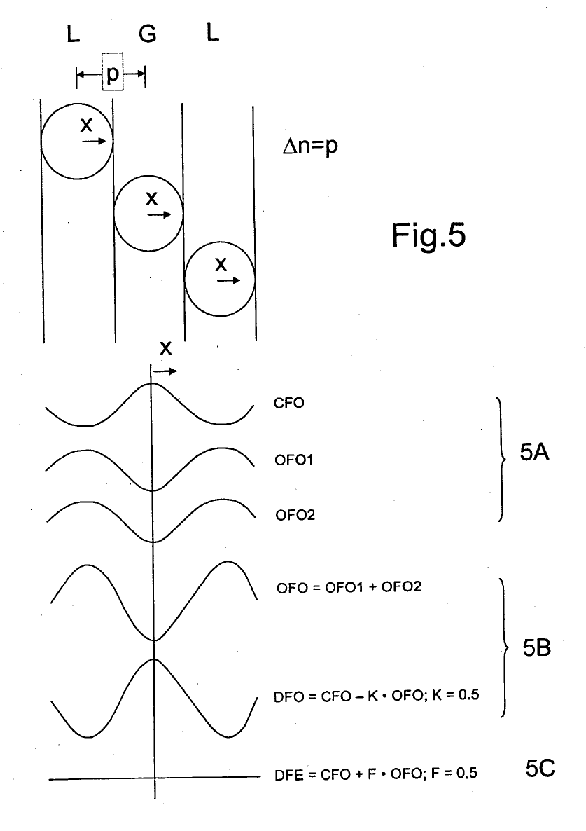

FIG. 5 shows the arrangement of FIG. 4A, together with characteristics of components that are dependent on focus error and occur in the case of radial movement,

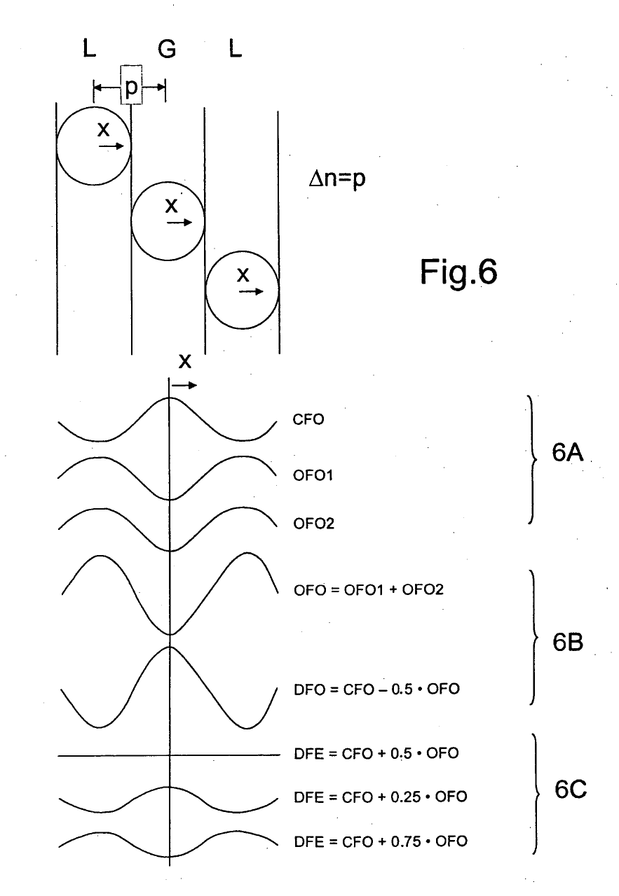

FIG. 6 shows the arrangement of FIG. 4A, together with characteristics of the signals used for determining DFE,

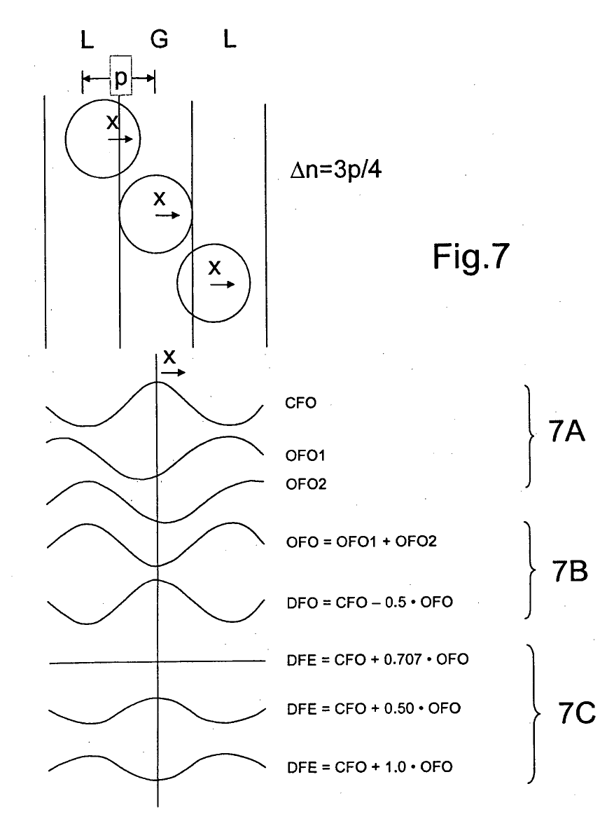

FIG. 7 shows an arrangement with a beam spacing Δn=3p/4, together with characteristics of the signals used for determining DFE,

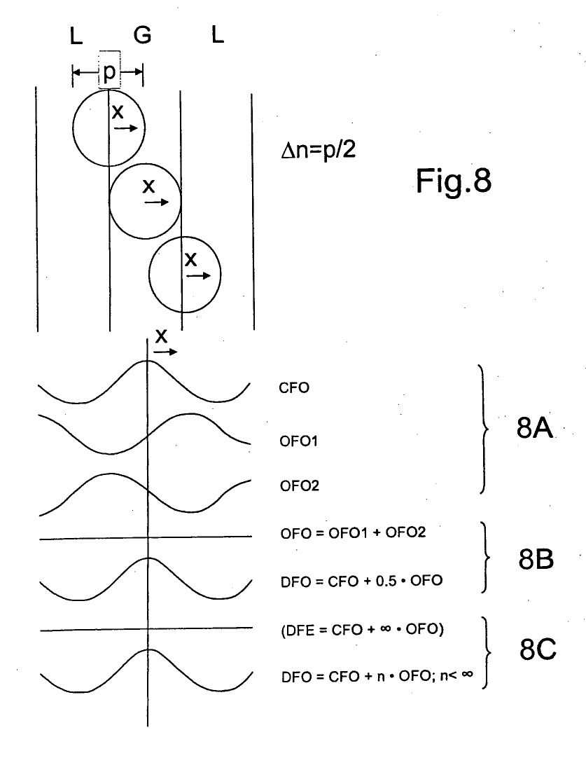

FIG. 8 shows an arrangement with a beam spacing Δn=p/2, together with characteristics of the signals used for determining DFE,

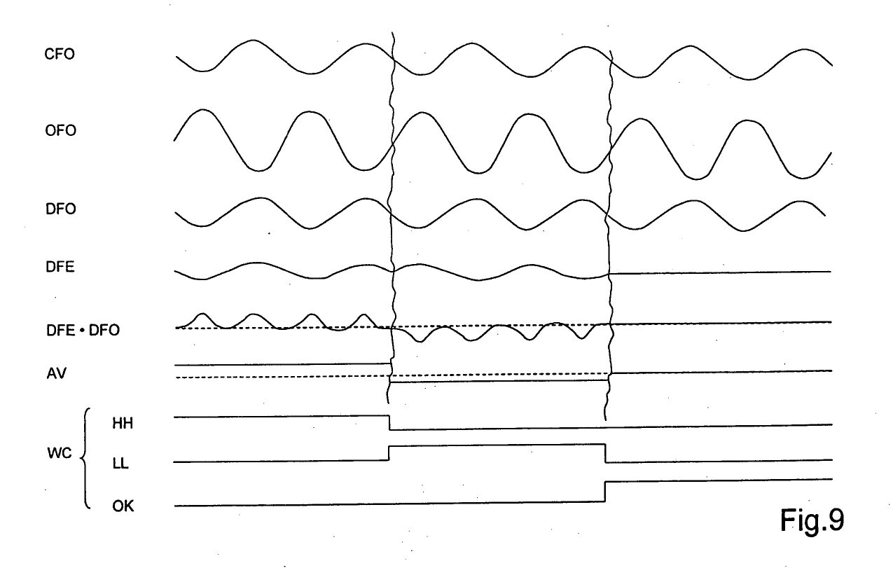

FIG. 9 shows temporal signal characteristics for the application of a first adjustment method,

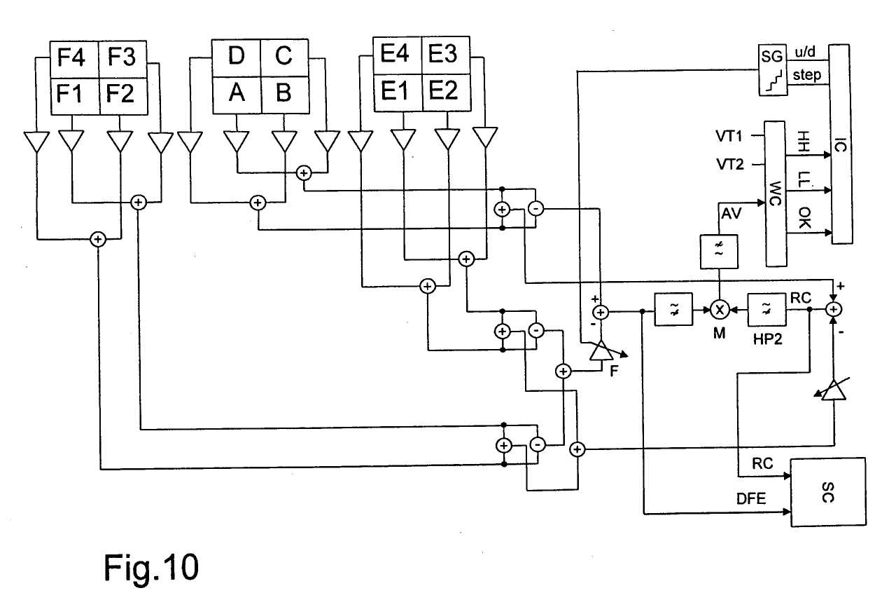

FIG. 10 shows the block diagram of an arrangement for applying a first adjustment method,

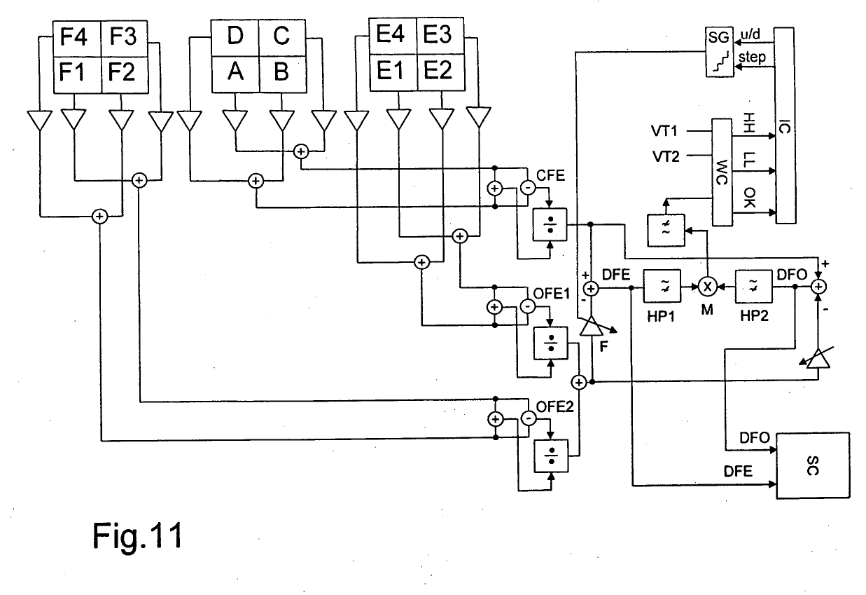

FIG. 11 shows the block diagram of a further arrangement for applying an adjustment method,

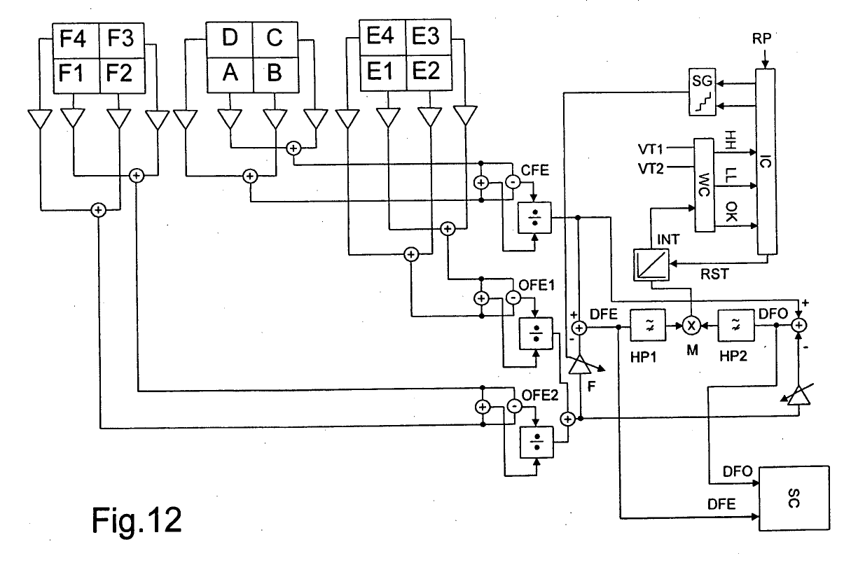

FIG. 12 shows the block diagram of a further arrangement for applying an adjustment method,

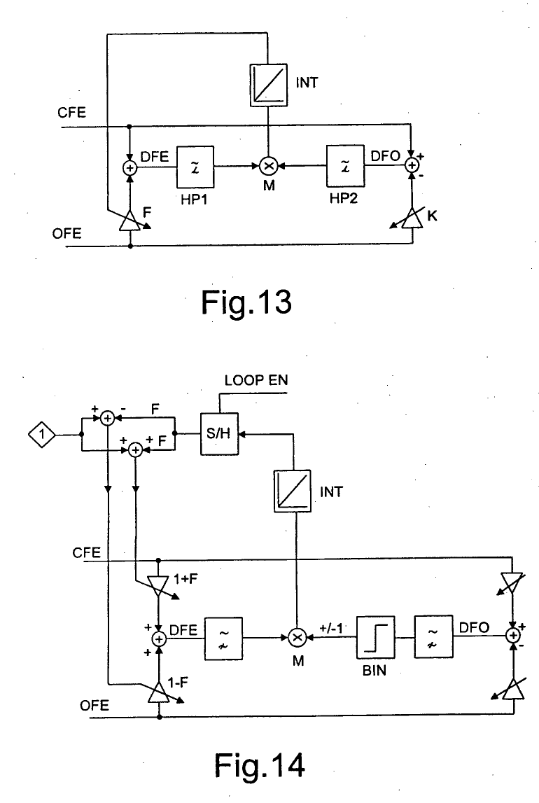

FIG. 13 shows the block diagram of an arrangement for obtaining the signals DFE, DFO from the signals CFE, OFE,

FIG. 14 shows the block diagram of a further arrangement for obtaining the signals DFE, DFO from the signals CFE, OFE,

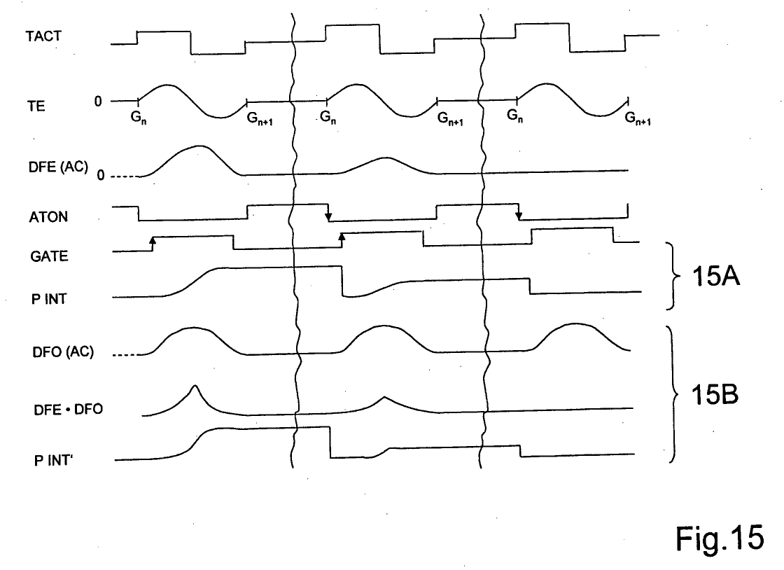

FIG. 15 shows temporal signal characteristics for individual consecutive track jumps in the case of differently adjusted weighting,

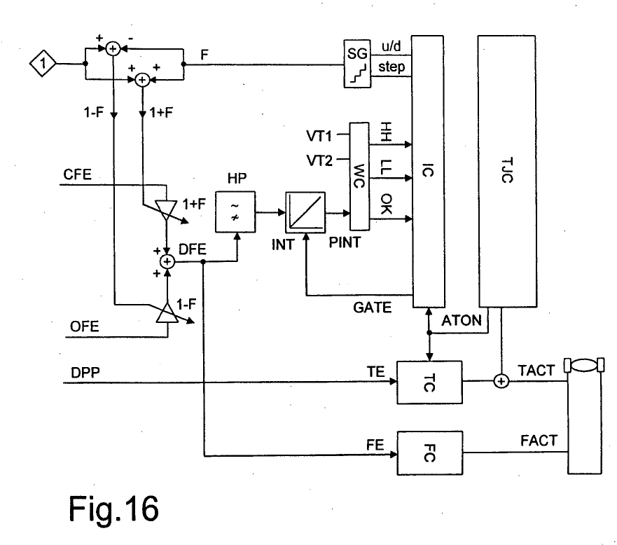

FIG. 16 shows the block diagram of the arrangement belonging to the signal characteristics of FIG. 15,

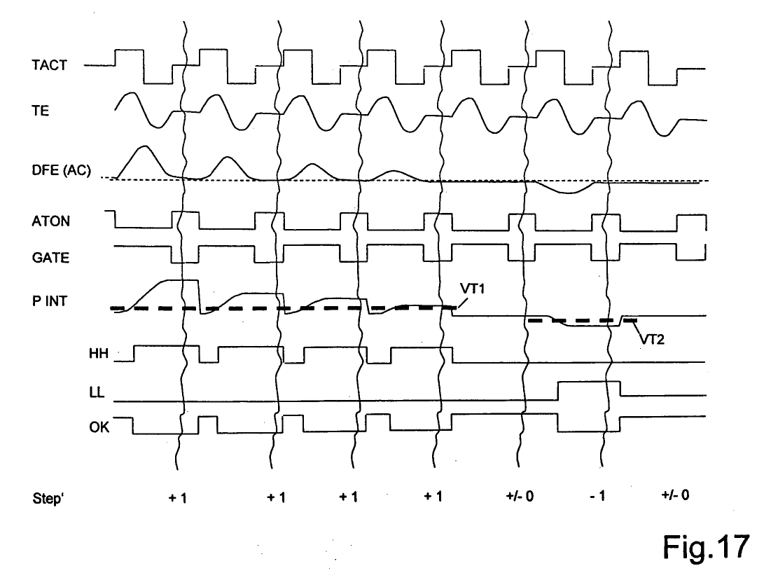

FIG. 17 shows signal characteristics for an adjustment operation comprising a number of individual track jumps,

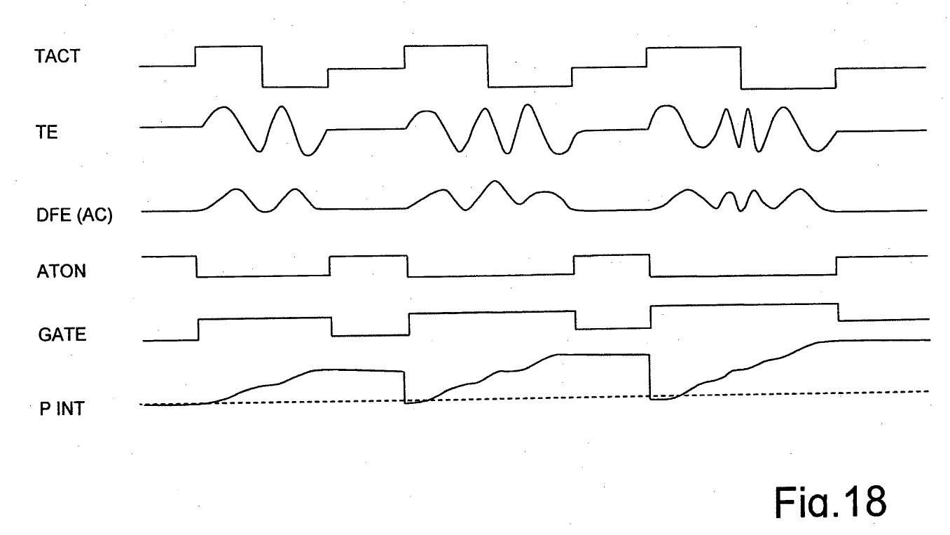

FIG. 18 shows signal characteristics for multiple track jumps that cross over different numbers of tracks.

As already mentioned above, the track position of the secondary beams is usually complementary to the track position of the main scanning beam given an appropriate angle of adjustment of the optical grating. This is shown in FIG. 5A. If the objective lens is displaced in the horizontal direction x relative to the tracks of the optical storage medium, at a specific instant, for example, the main scanning beam then lies in such a way that it is scanning precisely the middle of a secondary track of type L. In this case, the secondary scanning beams each lie precisely in the middle of a track of type G. At this instant, the component CFO dependent on focus offset and occurring for the secondary track L, acts on the main scanning beam, while the component OFO1, OFO2 dependent on the focus offset and acting on the scanning track G acts for the secondary scanning beams. Acting in addition on all three scanning beams in like manner is one component dependent on focus error, that is to say a component depending on the vertical distance error. This is not illustrated in FIGS. 5A-C, since it is only the components dependent on focus offset and caused by the horizontal displacement of the scanning beams that are visible here. Since the horizontal track position of the three beams can change only jointly, the focus offset components change simultaneously as a function of the instantaneous track position.

In order to obtain the focus offset components produced during displacement of the scanning beams in the horizontal direction, the individual secondary beam error signals OFE1, OFE2 are firstly added and produce a secondary beam error signal OFE that contains the component OFO of the secondary scanning beams that is dependent on focus offset. The secondary beam error signal OFE is subsequently subtracted from the main beam error signal CFE by applying a predeterminable weighting K, as a result of which a differential focus offset signal DFO is generated.

Since the abovementioned focus offset components have a mutually different sign depending on track type, while the focus error components are in phase with one another, given a correctly adjusted weighting F the focus error components, dependent on the vertical distance of the objective lens from the information layer, in the generated signal DFE are added together, while the focus offset components dependent on the horizontal position of the track precisely cancel one another out in the sum, as shown in FIG. 5C. Given correct weighting, the signal DFO therefore still only contains the focus offset component, while given correct weighting there is no longer any focus offset component contained in the signal DFE. Consequently, the signal DFO contains information relating to the radial position of the beams relative to the tracks G, L.

As shown in FIG. 5, the beam spacing Δn between main and secondary beams is usually adjusted to Δn=p. Here, p is defined as the distance between the middle of the track G and the middle of the secondary track L. In a departure from the usual beam spacing Δn=p between main and secondary beams it is possible, as in FIGS. 5A-C, to vary the spacing An within sensible limits. The FIGS. 6A-6C, 7A-7C and 8A-8C show the resulting components DFO dependent on focus offset, in each case in the part figures A and B as well as the formation of the focus error signal DFE, in each case in the part figures C, for various beam spacings An.

The theoretical limit of the value for Δn is in the range of 0<Δn<2p, the limit that can be used in practice is in the range of p/2<Δn<3p/2, since the phases of the secondary beam components OFO1 and OFO2 are displaced relative to one another in the case of Δn=p/2 and Δn=3p/2 such that the component OFO no longer exists (FIG. 8C) and it is therefore no longer possible to compensate the component in DFE that is dependent on focus offset. The component OFO is inverted outside this limit that can be used in practice.

FIGS. 6C and 7C show how a falsely adjusted weighting factor F acts as a function of the track position during the generation of the DFE signal. For this purpose, the signal characteristics of the individual signals are shown as a function of the track position x. Typically, the components, dependent on the focus offset, for the respective scanning beam exhibit a maximum amplitude on the respective middle of the tracks L or G, while they have a zero crossing at the boundaries between G and L. The signal DFO reaches its greatest positive amplitude at the middle of the groove, and its greatest negative amplitude at the middle of the land.

If the main beam component is weighted too strongly by comparison with the secondary beam components, the resulting signal DFE contains a component that is dependent on focus offset and which is in phase with the signal DFO. If, by contrast, the secondary beam components are overweighted with reference to the main beam component, a component that is dependent on focus offset is produced in the signal DFE and is in phase opposition to DFO. In order to ensure that the component dependent on focus offset is no longer contained in the DFE signal, the weighting factor between the main beam signal and secondary beam signal must be correctly adjusted.

In order to carry out a first adjustment method, it is necessary for the scanning beam to move relative to the tracks such that the various track positions are traversed as shown in FIG. 9. This can be done by activating the focus control loop of the reading or playback device, and the focusing objective lens is moved in such a way that there is a relative movement of the scanning beam relative to the tracks. Because of the eccentricity usually occurring in the optical storage medium, there is a movement of the scanning beam relative to the tracks even without a movement of the objective lens owing to a drive voltage. The first adjustment method is in multiplying the signal DFE as a first measurement signal by a suitable second measurement signal that, for example, has its greatest positive amplitude on the middle of the groove and its greatest negative amplitude at the middle of the land, see FIG. 10. It is also possible to apply an inverted behavior of such a suitable signal.

Thus, for example, the AC component of the mirror signal or of the radial contrast signal RC has such a suitable behavior. The radial contrast signal RC is formed by subtracting the weighted sum of the signals of the detectors A, B, C, D illuminated by the main beam from the weighted sum of the signals of the detectors E1-E4, F1-F4 illuminated by the secondary beams. As already described, in this case the secondary beams illuminate the track respectively complementary to the main beam. If there is a difference in contrast between groove and land, a radial contrast signal RC is produced whose AC component exhibits the suitable properties. Before the multiplication M, the RC signal must therefore traverse an AC coupling HP2. If, however, there is no difference in contrast between groove and land, as can be the case specifically with media that have not been played, no suitably useful signal is produced for multiplication by the DFE signal. The focus error signal DFE and a suitable track error signal RC are fed in each case to the servocontrol unit SC.

A signal which has a suitable characteristic even without a difference in contrast between groove and land is the abovedescribed DFO signal. For this reason, the DFO signal is advantageously suitable for being multiplied as second measurement signal by the signal DFE, see FIG. 11. The two measurement signals are advantageously additionally subjected before the common evaluation by multiplication M to highpass filtering HP1, HP2 in order to suppress possible DC components of the signals DFE and DFO. Depending on the weighting F adjusted, the result of the evaluation that is shown at the output of the multiplier M is an oscillating DC voltage as in FIG. 9, whose sign represents the phase and whose mean value AV, alternatively whose peak value, represents the absolute value of the component in the DFE signal that is dependent on focus offset. The aim is to adjust the weighting F such that the value of this oscillating DC voltage is brought as far as possible to zero.

Exactly as in FIG. 10, this is established, for example, by means of a window comparator WC whose reference voltages VT1, VT2 are adjusted to predeterminable values. In this case, these reference values VT1, VT2 are to be selected precisely to be so small that the oscillating DC voltage is sufficiently small, and the resulting adjustment associated therewith of the weighting F is within prescribed limits in the vicinity of the optimum weighting. When the outputs of the window comparator WC indicate that the value of the product lies inside the window—see output signal OK—this means that the correct adjustment of the weighting F has already been found. When the value lies below or above the window, as indicated by the output signals LL and HH, respectively, this means that the weighting F must be adjusted in the direction of a greater main beam component or secondary beam component—see also FIG. 9. After each complete oscillation of the signal DFO, a control circuit IC evaluates the instantaneous output signals HH, LL, OK of the window comparator WC, and controls the adjustment of the weighting F in the next step with the aid of the step generator SG. As shown in FIG. 11, this adjustment can be performed in a stepwise approximation or iteration to the correct value of the weighting. Alternatively, the next weighting adjustment can be calculated on the basis of a gradient calculation. The control circuit IC repeats these adjustment steps until the mean value (or the peak value) of the product of DFE and DFO lies inside the prescribed window.

A further and particularly advantageous variant relating to the adjustment of the weighting factor is described below with the aid of FIG. 12. When using this variant, it is likewise assumed that the focus controller is already activated and that there is a movement of the scanning beam relative to the tracks of the optical storage medium. Here, as well, use is made of a multiplier M in order to multiply the DFE signal, optionally subjected to highpass filtering in the unit HP1, as first measurement signal by the DFO signal, likewise optionally subjected to highpass filtering in the unit HP2, as second measurement signal. In the course of the joint evaluation, the output signal of the multiplier M is then integrated by means of an integrator INT. The integrator has a reset input that causes the integration voltage to start with the value zero during driving. As described above, the output signal of the integrator is evaluated with the aid of a window comparator WC.

After a prescribed time, a control circuit IC evaluates the respective output signals of the window comparator WC, and controls the adjustment of the weighting F accordingly. Subsequently, the control circuit IC sets the integrator INT to zero with the aid of the reset signal RST before a new time-controlled measurement cycle begins. Within the time, prescribed by a measurement cycle signal RP, of each measurement cycle, a relatively large number of track crossings of the scanning beam are taken into account for forming the product of DFE and DFO. After the prescribed measuring time, the integration starting with the value zero produces an integration value that corresponds to the average value of the product of DFE and DFO, and thus to the error of the weighting.

As shown in FIG. 12, the weighting can be adjusted in stepwise approximation or iteration to the correct value. Alternatively, the next weighting adjustment can be calculated on the basis of a gradient calculation.. The control circuit IC repeats these adjustment steps until the integration value of the product of DFE and DFO lies inside the prescribed window.

The advantage of the second variant is that a larger number of track crossings of the scanning beam are taken into account within the measurement time prescribed by RP in order to form the product of DFE and DFO. Any possible components of noise or interference are averaged out by the use of integration.

As an alternative to pure time control of the measurement cycle, the measurement cycle RP can also be adapted to the revolution of the optical storage medium. Thus, a measurement cycle RP can last for a fraction or else a number of revolutions of the optical storage medium.

In a third variant, shown in FIG. 13, use is made once again of a multiplier M in order to multiply the DFE signal, optionally subjected to highpass filtering in HP1, as first measurement signal with the DFO signal, likewise optionally subjected to highpass filtering in HP2, as second measurement signal as part of the joint evaluation. As shown in FIG. 14, it is possible as an alternative to binarize the DFO signal optionally subjected to highpass filtering and which typically has a sinusoidal characteristic, before the multiplication in a unit BIN, the outputs of the binarizer BIN being +1 or −1. The multiplier M then multiplies the DFE signal by +1 or −1, thereby once again producing an oscillating DC voltage whose sign represents the phase and whose amplitude represents the absolute value of the component dependent on focus offset in the DFE signal. As a further part of the joint evaluation, the output signal of the multiplier M is integrated by means of an integrator INT that changes its output voltage until the value of the multiplication vanishes. This is the case precisely when the optimum weighting factor is reached. If the output voltage of the integrator is accordingly connected to the weighting adjustment by means of a matching circuit, the result is a control loop that, because of the integrator INT in the feedback branch, is automatically adjusted such that the input signal of the integrator INT vanishes. This is the case precisely when the correct weighting F is adjusted and the output signal of the multiplier M vanishes.

The weighting factor F can be determined relatively accurately with the aid of the two last variants of the first adjustment method described, in particular. All the variants can advantageously be implemented by means of digital signal processing or by means of a digital signal processor. It is a precondition for carrying out the specified adjustment method that a movement of the scanning beam takes place relative to the tracks of the optical storage medium, the track controller typically being deactivated. As already mentioned above, it is possible in all the variants also to make use of any other signals for multiplication by DFE, instead of the DFO signal, given that they exhibit their greatest positive amplitude on the middle of a groove and their greatest negative amplitude on the middle of the land. If there is a contrast between G and L, it is also possible in principle to make use of the AC-coupled mirror signal or of the RC signal as second measurement signal.

In accordance with one of the abovedescribed adjustment methods, the determination of the weighting factor is usually a constituent within a sequence of a number of adjustment steps that are carried out after switching on a device for reading from or writing to an optical storage medium. These adjustment steps are carried out before starting a reading or writing operation for example.

A further adjustment method that also operates during the reading or writing mode is to be described below. The adjustment method utilizes the property that a device for reading from or writing to an optical storage medium also carries out track jumps over at least one to a number of tracks during the reading or writing operation in order to position the optical scanner. Determining the correct weighting during the reading or writing operation permits any possible changes to the properties of the device, in particular of the optical scanner and of the focus control loop as a consequence of heating or other influences, also to be compensated during operation.

FIG. 15 shows how, in the case of a single track jump, the main beam and secondary beam focus offset components CFO, OFO of the signals CFE and OFE produced by calculating the photodetector signals, as well as the resulting signals DFE and DFO appear for a variously adjusted weighting of DFE when the scanning beams move by Ax from the middle of a track Gₙ to a track Gₙ₊₁. Shown in addition is a signal TACT that shows the voltage applied to move the actuator for a track jump, as well as a track error signal TE. Likewise shown are a signal GATE and a signal ATON, the signal GATE marking the evaluation of the DFE signal, while the signal ATON marks the time intervals in which track jumps take place. The evaluation period limited by GATE is usually shorter or equal to the time interval that is described by ATON. Because of their definition, the signals ATON and GATE also contain information relating to the radial position of the beams relative to the tracks G, L. As shown in FIG. 15A, a signal PINT is formed as evaluation signal by integrating the DFE signal, the integrator likewise being controlled by the GATE signal in order to form the signal PINT.

An exemplary arrangement corresponding to the described sequence is shown in FIG. 16. Both the focus controller FC and the track controller TC are active before the start of a track jump. At the start of a track jump, the track jump control unit TJC uses the signal ATON to deactivate the track controller TC and generates the signal TACT such that the actuator carries out a track jump by exactly one track. The evaluation signal PINT is obtained from the signal DFE as first measurement signal by integration INT, the integrator voltage starting at zero after being enabled by the signal GATE functioning here as second measurement signal. The initial value of the signal DFE before the track jump is usually close to zero because of the activated focus controller FC. The signal DFE can advantageously further be AC-coupled in the unit HP before the integration.

If the main beam component is weighted too strongly by comparison with the secondary beam components, the resulting signal DFE therefore contains a component that is dependent on focus offset and generates a signal characteristic of positive polarity. If, by contrast, the secondary beam components are overweighted with reference to the main beam component, a component that is dependent on focus offset and generates a signal characteristic of negative polarity is thus produced in the signal DFE. If the correct weighting F is adjusted, the component dependent on focus offset that is contained in the DFE signal vanishes. In accordance with the amplitude and the polarity of the components contained in the DFE signal that are dependent on focus offset, the signal PINT at the end of the time interval prescribed by GATE reaches a positive or negative final value if the weighting has been wrongly adjusted. The output voltage PINT of the integrator vanishes whenever the correct weighting is adjusted, as illustrated in FIG. 17.

The output voltage PINT of the integrator is, for example, evaluated by means of a window comparator WC whose reference voltages VT1, VT2 are adjusted to predeterminable values. In this case, these reference voltages are selected to be precisely so low that the value PINT of the integrator is sufficiently small, and the resulting adjustment, associated therewith, of the weighting F lies within prescribed limits in the vicinity of the optimum adjustment. The outputs of the window comparator WC indicate whether the correct adjustment of the weighting has already been found, or whether it is necessary to adjust the weighting to the main beam component or to the secondary beam component. After a track jump that has been executed completely, a control circuit IC evaluates the instantaneous output signals of the window comparator and correspondingly controls the adjustment of the weighting F. This adjustment can be performed in a stepwise approximation or iteration to the correct value of the weighting. As an alternative, it is possible to calculate the next weighting adjustment on the basis of a gradient calculation. The control circuit IC evaluates consecutive track jumps and carries out the stepwise adjustment of the weighting F until the output signal PINT of the integrator lies inside the prescribed window.

As shown in FIG. 15B, it is possible as an alternative to the integration of the DFE signal controlled by the signal GATE initially to multiply the DFE signal as first measurement signal by the DFO signal as second measurement signal and to integrate the product produced in the course of the evaluation. This has the advantage that the components in the DFE signal that are dependent on focus offset are more strongly weighted by the signal characteristic of the DFO signal. The signal PINT′ is to be treated further as described above.

The diagram illustrated in FIG. 18 shows that a multiple track jump can be used instead of a single track jump in order to determine the adjustment of the weighting. However, the reference voltage of the window comparator is to be matched in accordance with the number of tracks crossed. In order to illustrate this, jumps are shown over two, three and four tracks in FIG. 18 in conjunction with a weighting assumed to be constantly maladjusted. The resulting integrator voltage PINT is dependent in this case on the number of the tracks crossed. The aim here is also to reduce the components in the DFE signal that are dependent on focus offset to zero as far as possible, irrespective of the number of the tracks crossed, as is described above for the individual track jump.

Advantages of the invention are ease of implementation and compensation of possible changes in the properties of the device, in particular of the optical scanner as well as of the focus control loop as a consequence of heating or other influences even during operation.

1. A method for adjusting a weighting factor in a device for reading from and/or writing to optical recording media which generates a focus error signal in accordance with the differential focus error method, having the steps of:
switching on the focus control loop and generating a differential focus error signal,
initiating a track crossing operation,
setting differential focus error signal and a measurement signal into relation with one another, and
changing the weighting factor as a function of the differential focus error signal set into relation.

2. The method as claimed in claim 1 in a scanning unit for optical recording media having data filed in tracks wherein the scanning unit has an objective lens, which can adopt various distances relative to the recording medium, a focus control loop and a tracking control loop; generates an optical main beam and at least one secondary beam, focuses the main and secondary beams onto the recording medium, evaluates the light reflected by the recording medium with the aid of several photodetector segments assigned to the beams, derives a first error signal from the signals of the photodetector segments assigned to the main beam, and derives a second error signal from the signals of the photodetector segments assigned to the secondary beams, and wherein in the method the focus error signal is formed by combining the first error signal (CFE), multiplied by a first branch weight (1+T, 1+F), and the second error signal, multiplied by a second branch weight;
defined by the steps of:
initiating a track crossing operation;
measuring two measurement signals, that are differently formed and contain information relating to the distance of the objective lens from the recording medium and relating to the radial position of the beams relative to the tracks;
evaluating the measurement signals; and
adjusting the branch weight in a fashion controlled by the result of the evaluation.

3. The method as claimed in claim 2, wherein at the start of the application of the method the tracking control loop is switched on, during a control pulse a jump over at least one track is carried out, the first measurement signal is formed from the focus error signal, the second measurement signal is formed from the control pulse or from a differential focus offset signal, and the evaluation of the measurement signals comprises an integration of the product of the two measurement signals to form an evaluation signal and, thereafter, comparison of the latter with a comparison interval; and wherein, when the evaluation signal does not lie in the comparison interval, the branch weights are varied in at least one adjustment step such that the evaluation signal changes toward the comparison interval.

4. The method as claimed in claim 2, wherein the tracking control loop is switched off.

5. The method as claimed in claim 4, wherein the objective lens is moved transverse to the tracks.

6. The method as claimed in claim 4, in the case of which the first measurement signal is formed from the focus error signal, the second measurement signal is formed from a signal that has its greatest positive or negative amplitudes at the middle of the tracks, the evaluation of the measurement signals comprises forming an evaluation signal from the product of the two measurement signals and comparing it with a comparison interval, and in which, when the evaluation signal does not lie in the comparison interval, the branch weights are varied in at least one adjustment step such that the evaluation signal changes toward the comparison interval.

7. The method as claimed in claim 6, in which the second measurement signal is formed from a mirror signal, a radial contrast signal or a differential focus offset signal.

8. The method as claimed in claim 6, in which the formation of the evaluation signal comprises an integration of the product of the measurement signals, and a sequence controller is present that resets the result of the integration to zero before each measurement.

9. The method as claimed in claim 4, in which the first measurement signal is formed from the focus error signal, the second measurement signal is formed from a binarized differential focus offset signal, the evaluation of the measurement signals comprises forming an evaluation signal from the integral of the product of the two measurement signals and comparing the evaluation signal with a comparison interval, and in which, when the evaluation signal does not lie in the comparison interval, the branch weights are varied in at least one adjustment step such that the evaluation signal changes toward the comparison interval.

10. The method as claimed in claim 8, in which the integration is performed over a predetermined time or over a time proportional to the scanning speed.

11. The method as claimed in claim 3, in which the change in the branch weights is performed in a stepwise fashion in small steps or by calculating the respectively new branch weights from one or more interpolation values.

12. A device for carrying out one of the methods as claimed in claim 1.
